(19) United States
(12) Patent Application Publication
(10) Pub. No.: US 2024/0150194 A1
(43) Pub. Date: May 9, 2024

(54) LOW-CARBON HIGH-PURITY TANTALUM PENTOXIDE POWDER AND PREPARATION METHOD AND USE THEREOF

(71) Applicant: NINGXIA ORIENT TANTALUM INDUSTRY CO., LTD., Shizuishan (CN)

(72) Inventors: Shun Guo, Shizuishan (CN); Jinfeng Zheng, Shizuishan (CN); Tao Guo, Shizuishan (CN); Hongyuan Liang, Shizuishan (CN); Yuewei Cheng, Shizuishan (CN); Jingyi Zuo, Shizuishan (CN); Li Zhang, Shizuishan (CN); Ying Wang, Shizuishan (CN); Tong Liu, Shizuishan (CN); Hongjie Qin, Shizuishan (CN)

(73) Assignee: NINGXIA ORIENT TANTALUM INDUSTRY CO., LTD., Shizuishan (CN)

(21) Appl. No.: 18/284,211

(22) PCT Filed: Aug. 24, 2022
(86) PCT No.: PCT/CN2022/114374

§ 371 Date: Sep. 26, 2023

(30) Foreign Application Priority Data
Dec. 15, 2021 (CN) 202111532673.8

(51) Int. Cl. C01G 35/00

(52) U.S. Cl. CPC C01G 35/00; C01P 2006/80

(57) ABSTRACT

A low-carbon, high-purity tantalum pentoxide powder has a carbon content of no greater than 15 ppm. A preparation method for the powder includes: (1) adding a fluotantalic acid (H₂TaF₇) solution into a reaction kettle, controlling the temperature of the reaction kettle at 30-60° C., adding a precipitator until the pH of the reaction solution is 8-10, then stopping introducing ammonia, and aging to obtain a tantalum hydroxide slurry; (2) filtering and washing the slurry obtained in step (1), and then carrying out solid-liquid separation to obtain a tantalum hydroxide filter cake; (3) drying the filter cake obtained in step (2) to obtain white tantalum hydroxide powder; (4) calcining the tantalum hydroxide powder obtained in step (3), crushing and screening the calcined sample to obtain tantalum pentoxide powder; and (5) subjecting the tantalum pentoxide powder obtained in step (4) to heat treatment at a temperature of 1000-1500° C. to obtain the powder.

### CROSS REFERENCE TO RELATED APPLICATION

The present application is the National Stage of International Patent Application No. PCT/CN2022/114374, filed on Aug. 24, 2022, which claims priority to and all the benefits of Chinese Application No. 202111532673.8, filed on Dec. 15, 2021, which are hereby expressly incorporated herein by reference in their entirety.

### TECHNICAL FIELD

The present invention relates to the field of powder production, in particular to low-carbon high-purity tantalum pentoxide powder and preparation method and use thereof.

### BACKGROUND

Tantalum pentoxide (also commonly known as tantalum oxide) is a raw material for producing metallic tantalum, and is also used in electronics industry, for producing lithium tantalate single crystals and for producing optical glass (especially high-refractive low-dispersion special optical glass), and in chemical industry as a catalyst.

In the prior art, tantalum oxide is mainly prepared by neutralization precipitation method. Using tantalum-niobium concentrate as raw material, the method comprises forming a tantalum liquid in the process of separating tantalum and niobium by liquid-liquid extraction method, the tantalum liquid comprising tantalum in the form of H₂TaF₇, and a certain amount of HF and H₂SO₄, neutralizing the tantalum liquid with aqueous ammonia till pH=8-10 to obtain white tantalum hydroxide that is insoluble in water, then drying and calcining to obtain tantalum oxide. CN104386751A and CN104310323A disclose the related techniques. However, these techniques has the disadvantage that it is difficult to remove carbon from tantalum oxide sufficiently. Unfortunately, too high a carbon content is particularly detrimental to the purity of tantalum pentoxide, which limits the use of tantalum pentoxide in the preparation of high purity materials, such as the preparation of high purity tantalum powder and the growth of high purity lithium tantalate crystals.

Many studies have been made in the prior art, however, the problem of further reducing the carbon content in tantalum pentoxide has not yet been solved.

### DISCLOSURE

The present invention relates to low-carbon high-purity tantalum pentoxide. As used herein, “low-carbon high-purity” tantalum pentoxide or “high-purity” tantalum pentoxide refers to tantalum pentoxide having a carbon content of no greater than 15 ppm. Preferably, the carbon content therein is from 10 ppm to 15 ppm, preferably from 3 ppm to 10 ppm.

Although tantalum oxide is a commonly known name for tantalum pentoxide, tantalum pentoxide is used primarily herein to denote Tb₂O₅ for the sake of preciseness.

The present invention relates to a preparation method of the tantalum pentoxide powder, which comprises the following steps:

(1) adding a fluotantalic acid (H₂TaF₇) solution into a reaction kettle, controlling the temperature of the reaction kettle at 30-60° C. (preferably 40-50° C.), adding a precipitator until the pH of the reaction solution is =8-10 (preferably 8-9.5), then stopping introducing ammonia, and aging (for example, aging for 2-5 h, preferably 3-4 h) to obtain a tantalum hydroxide slurry;

(2) filtering and washing the tantalum hydroxide slurry obtained in step (1), and then carrying out solid-liquid separation to obtain a tantalum hydroxide filter cake;

(3) drying the filter cake obtained in step (2) to obtain white tantalum hydroxide powder;

(4) calcining the tantalum hydroxide powder obtained in step (3), crushing and screening the calcined sample to obtain tantalum pentoxide powder; and

(5) subjecting the tantalum pentoxide powder obtained in step (4) to heat treatment at a temperature of 1000-1500° C. to obtain high-purity tantalum pentoxide powder.

More preferably, when the pH of the reaction solution in step (1) is 8-9, the addition of the precipitator is stopped.

In step (1), the fluotantalic acid (H₂TaF₇) solution has an oxide content, preferably calculated as Ta₂O₅, of 20-80 g/L, and more preferably 35-65 g/L. The term “calculated as Ta₂O₅” will be clear to those skilled in the art. However, in order to make it easier for those skilled in the art to understand, the applicant explains the term “calculated as Ta₂O₅” as follows. This is a common method to represent the concentration of a fluotantalic acid solution (sometimes referred to as “tantalic acid solution” herein), wherein the content of tantalum, which exists in a fluotantalic acid solution mainly in a complex form, is detected during the measurement, and then converted into the content of Ta₂O₅ to represent the concentration of the tantalic acid solution. The method is specifically carried out in accordance with the Chinese national standard GB/T15076.1.

In step (1), the precipitator includes, but is not limited to, one or more selected from the group consisting of sodium bicarbonate, ammonium carbonate, urea, aqueous ammonia, ammonia gas, and sodium hydroxide. Preferably, aqueous ammonia is used as the precipitator; at this time, the addition of the precipitator may also be referred to as introduction of ammonia gas. The introduction rate of aqueous ammonia is not limited, but slow introduction is preferred. In step (1), stirring is preferably performed in the reaction kettle. More preferably, the stirring time is 5-10 min.

Preferably, the aging time (also referred to as rest time) in step (2) is 2-5 h. More preferably the aging time is 3-4 h. Preferably, the filtering and washing in step (2) is repeated a plurality of times. For example, the filtering and washing may be performed by: adding the tantalum hydroxide solution obtained in step (1) into a filtering and washing tank, and then filtering and washing with hot pure water (for example, hot pure water at 90-100° C.). Preferably, the solid-liquid separation is carried out by means of negative pressure suction filtration.

Preferably, the drying is performed in step (3) by: placing the filter cake in a hot air oven and drying at 80-180° C. (preferably 100-160° C., and more preferably 120-140° C.), for example, for 8-12 h (preferably 10-11.5 h).

Preferably, the calcination in step (4) is carried out by loading the tantalum hydroxide powder obtained in step (3) into a crucible and placing in a furnace. The furnace used herein is preferably a muffle furnace. Preferably, the calcination temperature is 900-1000° C. (preferably 800-900° C.), and the calcination time is 8-12 h (preferably 9-11 h).

The temperature of the high-temperature calcination heat treatment in step (5) is preferably 1200-1500° C. (for example 1400° C.), and the time is preferably 1-3 h. In step (5), the sintering heat treatment atmosphere includes, but is not limited to, vacuum, inert atmosphere (such as helium, argon, neon, etc.), and atmospheric atmosphere. Vacuum is more preferred.

Preferably, the temperature of the high-temperature vacuum heat treatment in step (5) is 1200-1400° C., and more preferably 1200-1300° C. Preferably, the heat treatment time is 1-3 h.

Preferably, the carbon content of the high-purity tantalum pentoxide powder obtained in step (5) is 10-15 ppm, preferably 3-10 ppm.

The present invention also relates to use of the above tantalum pentoxide powder for the production of lithium tantalate single crystals and catalysts and for the production of optical glass, such as high-refractive low-dispersion optical glass.

Without being bound to a general theory, after a great deal of research, the inventors believe that the main reason why it is difficult to further reduce the carbon content in the prior art is: in the production process of preparing high-purity tantalum pentoxide by neutralization precipitation method, a large amount of organic matter is mostly used as an extracting agent in the early liquid-liquid extraction process, and the extracting agent cannot be completely removed in the subsequent process, so that the high-purity tantalum pentoxide powder has a high carbon content. Due to the “inheritance” of the carbon impurity content, in the process of preparing tantalum powder by tantalum pentoxide, the carbon content in tantalum powder will exceed the standard.

After a great deal of research, the inventors find that a desirable low-carbon high-purity tantalum pentoxide powder can be obtained according to the method of the present invention.

### EXAMPLES

In order to better illustrate the present invention, the following examples are provided. These examples are only for the purpose of better understanding the present invention by those skilled in the art, and are not intended to limit the present invention.

The examples were carried out under conventional conditions if the specific conditions are not specified. The reagents or instruments used are commercially available conventional products if the manufacturer is not specified.

For the purposes of the present specification, all numbers expressing amounts of ingredients, reaction conditions and the like in the specification and claims are to be understood as being modified in all instances by the term “about” unless otherwise indicated. Accordingly, the numerical parameters given in the following specification and attached claims are approximate values that may vary depending upon the desired properties sought to be obtained by the present invention, unless otherwise indicated. At the very least, and not intended to limit the application of the principle of equivalence in the scope of claims, each numerical parameter should be interpreted at least according to the number of reported significant digits and the usual rounding technique.

### Comparative Example 1

1. 100 L of fluotantalic acid solution, having an oxide content of 50 g/L calculated as Ta₂O₅, was added into a reaction kettle, and the reaction kettle was controlled at a temperature of 40° C. Aqueous ammonia was slowly introduced into the tantalic acid solution until the reaction solution had pH=9, resulting in a tantalum hydroxide slurry, which was then aged for 3 h.

2. The tantalum hydroxide slurry was transferred into a filtering and washing tank, the reaction precipitate was repeatedly filtered and washed by hot pure water at a temperature of 95° C., and finally solid-liquid separation was performed by means of negative pressure suction filtration to obtain a white filter cake.

3. The white filter cake was placed in a material tray, and then dried in a hot air oven for 10 h at a temperature of 100° C., to obtain white tantalum hydroxide powder.

4. The white tantalum hydroxide powder was loaded into a crucible, and calcined in a muffle furnace for 10 h at a temperature of 900° C., and then the sintered sample was crushed and screened to obtain tantalum pentoxide powder.

The carbon content of the tantalum pentoxide powder was analyzed in accordance with to the Chinese Standard GB/T15076.8, and the results are shown in Table 1.

### Example 1

1. 100 L of fluotantalic acid solution, having an oxide content of 50 g/L calculated as Ta₂O₅, was added into a reaction kettle, and the reaction kettle was controlled at a temperature of 40° C. Aqueous ammonia was slowly introduced into the tantalic acid solution until the reaction solution had pH=9, resulting in a tantalum hydroxide slurry, which was then aged for 3 h.

2. The tantalum hydroxide slurry was transferred into a filtering and washing tank, the reaction precipitate was repeatedly filtered and washed by hot pure water at a temperature of 95° C., and finally solid-liquid separation was performed by means of negative pressure suction filtration to obtain a white filter cake.

3. The white filter cake was placed in a material tray, and then dried in a hot air oven for 10 h at a temperature of 100° C., to obtain white tantalum hydroxide powder.

4. The white tantalum hydroxide powder was loaded into a crucible, and calcined in a muffle furnace for 10 h at a temperature of 900° C., and then the sintered sample was crushed and screened to obtain tantalum pentoxide powder.

5. The tantalum pentoxide powder was loaded into a crucible, and subjected to heat treatment in a high-temperature vacuum furnace for 2 h at a temperature of 1200° C., to obtain low-carbon tantalum pentoxide powder.

The carbon content of the tantalum pentoxide powder was analyzed in accordance with to the Chinese Standard GB/T15076.8, and the results are shown in Table 1.

### Comparative Example 2

1. 100 L of fluotantalic acid solution, having an oxide content of 35 g/L calculated as Ta₂O₅, was added into a reaction kettle, and the reaction kettle was controlled at a temperature of 60° C. Aqueous ammonia was slowly introduced into the tantalic acid solution until the reaction solution had pH=10, resulting in a tantalum hydroxide slurry, which was then aged for 3 h.

2. The tantalum hydroxide slurry was transferred into a filtering and washing tank, the reaction precipitate was repeatedly filtered and washed by hot pure water at a temperature of 95° C., and finally solid-liquid separation was performed by means of negative pressure suction filtration to obtain a white filter cake.

3. The white filter cake was placed in a material tray, and then dried in a hot air oven for 10 h at a temperature of 100° C., to obtain white tantalum hydroxide powder.

4. The white tantalum hydroxide powder was loaded into a crucible, and calcined in a muffle furnace for 10 h at a temperature of 800° C., and then the sintered sample was crushed and screened to obtain tantalum pentoxide powder.

The carbon content of the tantalum pentoxide powder was analyzed in accordance with to the Chinese Standard GB/T15076.8, and the results are shown in Table 1.

### Example 2

1. 100 L of fluotantalic acid solution, having an oxide content of 35 g/L calculated as Ta₂O₅, was added into a reaction kettle, and the reaction kettle was controlled at a temperature of 60° C. Aqueous ammonia was slowly introduced into the tantalic acid solution until the reaction solution had pH=10, resulting in a tantalum hydroxide slurry, which was then aged for 3 h.

2. The tantalum hydroxide slurry was transferred into a filtering and washing tank, the reaction precipitate was repeatedly filtered and washed by hot pure water at a temperature of 95° C., and finally solid-liquid separation was performed by means of negative pressure suction filtration to obtain a white filter cake.

3. The white filter cake was placed in a material tray, and then dried in a hot air oven for 10 h at a temperature of 100° C., to obtain white tantalum hydroxide powder.

4. The white tantalum hydroxide powder was loaded into a crucible, and calcined in a muffle furnace for 10 h at a temperature of 800° C., and then the sintered sample was crushed and screened to obtain tantalum pentoxide powder.

5. The tantalum pentoxide powder was loaded into a crucible, and subjected to heat treatment in a high-temperature vacuum furnace for 2 h at a temperature of 1350° C., to obtain low-carbon tantalum pentoxide powder.

The carbon content of the tantalum pentoxide powder was analyzed in accordance with to the Chinese Standard GB/T15076.8, and the results are shown in Table 1.

TABLE 1
Analytical results of low-carbon tantalum pentoxide

| Sample | Carbon content (ppm) |
|---|---|
| Comparative Example 1 | 102 |
| Example 1 | 12 |
| Comparative Example 2 | 110 |
| Example 2 | 7 |

It can be seen from Table 1 that the carbon content of the tantalum pentoxide powder obtained according to the method of the present invention is unexpectedly reduced, with a difference in order of magnitude.

1. A tantalum pentoxide powder having a carbon content of no greater than 15 ppm.

2. A method of preparing tantalum pentoxide powder, the method comprising the following steps:
(1) adding a fluotantalic acid (H₂TaF₇) solution into a reaction kettle, controlling the temperature of the reaction kettle at 30-60° C., adding a precipitator until the pH of the reaction solution is 8-10, then stopping introducing ammonia, and aging to obtain a tantalum hydroxide slurry;
(2) filtering and washing the tantalum hydroxide slurry obtained in step (1), and then carrying out solid-liquid separation to obtain a tantalum hydroxide filter cake;
(3) drying the filter cake obtained in step (2) to obtain white tantalum hydroxide powder;
(4) calcining the tantalum hydroxide powder obtained in step (3), and crushing and screening the calcined sample to obtain tantalum pentoxide powder; and
(5) subjecting the tantalum pentoxide powder obtained in step (4) to heat treatment at a temperature of 1000-1500° C. to obtain high-purity tantalum pentoxide powder.

3. The method according to claim 2, wherein, in step (1), the fluotantalic acid (H₂TaF₇) solution has an oxide content, calculated as Ta₂O₅, of 20-80 g/L; and/or the precipitator includes one or more selected from the group consisting of sodium bicarbonate, ammonium carbonate, urea, aqueous ammonia, ammonia gas, and sodium hydroxide; and/or stirring is performed in the reaction kettle.

4. The method according to claim 2, wherein the aging time in step (2) is 2-5 h; and/or the filtering and washing in step (2) is repeated a plurality of times; and/or, in step (2), the solid-liquid separation is carried out by means of negative pressure suction filtration.

5. The method according to claim 2, wherein the drying is performed in step (3) by placing the filter cake in a hot air oven and drying at 80-180° C.

6. The method according to claim 2, wherein the calcination in step (4) is carried out by loading the tantalum pentoxide powder obtained in step (3) into a crucible and placing in a furnace, and the furnace is a muffle furnace.

7. The method according to claim 2, wherein, in step (5), the temperature of the high-temperature calcination heat treatment is 1200-1500° C.; and/or the sintering heat treatment atmosphere includes vacuum, inert atmosphere, and atmospheric atmosphere.

8. A tantalum pentoxide powder obtained by the method according to claim 2 and having a carbon content of from 10 ppm to 15 ppm.

9. (canceled)

10. The tantalum pentoxide powder according to claim 1, wherein the carbon content is from 10 ppm to 15 ppm.

11. The method according to claim 2, wherein, in step (1), the temperature of the reaction kettle is controlled at 40-50° C., the precipitator is added until the pH of the reaction solution is 8-9.5, and the aging is conducted for 2-5 h.

12. The method according to claim 11, wherein, in step (1), the oxide content of the fluotantalic acid (H₂TaF₇) solution is 35-65 g/L; and/or the precipitator is aqueous ammonia; and/or the stirring is performed in the reaction kettle for 5-10 min.

13. The method according to claim 2, wherein, in step (1), the oxide content of the fluotantalic acid (H₂TaF₇) solution is 35-65 g/L; and/or the precipitator is aqueous ammonia; and/or the stirring is performed in the reaction kettle for 5-10 min.

14. The method according to claim 5, wherein the drying is performed in step (3) for 8-12 h.

15. The method according to claim 6, wherein the calcination temperature is 900-1000° C. and/or the calcination time is 8-12 h.

16. The method according to claim 2, wherein the calcination in step (4) is carried out by loading the tantalum pentoxide powder obtained in step (3) into a crucible and placing in a furnace, and the furnace is a muffle furnace; the calcination temperature is 800-900° C., and the calcination time is 9-11 h.

17. The method according to claim 2, wherein, in step (5), the temperature of the high-temperature calcination heat treatment is 1200-1400° C. and time is 1-3 h; and/or the sintering heat treatment atmosphere includes vacuum.
